(19) United States
(12) Patent Application Publication
(10) Pub. No.: US 2008/0319584 A1
(43) Pub. Date: Dec. 25, 2008

(54) PROCEDURE FOR CONTROLLING AN INJECTION VALVE

(75) Inventors: Michael Fischer, Niefern-Oeschelbronn (DE); Christian Bayer, Vaihingen (DE); Minh-Tam Ta, Vaihingen/Enz (DE); Peter Feuerstack, Ludwigsburg (DE); Jens Neuberg, Stuttgart (DE); Helerson Kemmer, Vaihingen (DE); Matthias Walz, WIERNSHEIM (DE); Anh-Tuan Hoang, Tamm (DE); Achim Deistler, Ludwigsburg (DE); Michael Clauss, Remseck (DE); Andreas Jakobi, Stuttgart (DE); Roland Waschler, Sindelfingen (DE); Harry Friedmann, Vaihingen An Der Enz (DE); Lars Moser, Leonberg (DE)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 12/126,111

(22) Filed: May 23, 2008

(30) Foreign Application Priority Data
May 23, 2007 (DE) 10 2007 023 898.5

(51) Int. Cl. G05D 7/06; F16K 31/02

(52) U.S. Cl. 700/282; 137/624.11

(57) ABSTRACT

The invention concerns a procedure for controlling an injection valve, at which the injection valve is supplied with current that is provided by a condenser during a holding phase, at which the injection valve is kept open. The invention further concerns a device for controlling an injection valve, which is customized to cause the condenser to provide the injection valve during a holding phase, at which the injection valve is kept open, with current.

### TECHNICAL FIELD

The invention concerns a procedure for controlling an injection valve and a device for controlling an injection valve as well as a computer program and a computer program product.

### BACKGROUND

In order to open and to keep open a typically inward opening injection valve, especially a high pressure injection magnet valve or a high pressure injection valve at benzine direct injection, a complex current profile is used for controlling. It provides a so-called booster phase, whereby by engaging the high pressure injection valve a high current with an abrupt boost is caused in a booster condenser, which stores energy as an electric voltage of e.g. 65 V and then delivers it to the high pressure injection valve during the booster phase. The current in the booster phase is independent of the battery voltage, as long as the booster condenser can provide a sufficient booster voltage. The complex current profile also provides a holding phase, whereby the current is reduced to a lower level or to a lower effective value and regulated around this effective value. The regulation takes place for example by engaging a solenoid valve on to the battery voltage.

The level of the booster and holding current that have to be adjusted are usually determined by a maximum system pressure, against which the high pressure injection valve has to be opened and closed, and by a static percolation of the fuel that has to be injected.

### SUMMARY OF THE INVENTION

The invention concerns a procedure for controlling an injection valve, at which the injection valve is supplied with current that is provided by a condenser during a holding phase, at which the injection valve is kept open.

Usually it is provided, that the current is provided by the condenser during a first phase, the so-called booster phase, during which the injection valve is opened and which precedes the holding phase. During this booster phase a current with a steeply ascending amperage is conducted trough the injection valve. According to the invention it is provided that the condenser, which is also called booster condenser and which is customized for providing a steep boost of the amperage, is additionally used to supply the injection valve during the holding phase with current and thereby to replace or complement a current source that is usually provided for supplying the injection valve with current, so that the injection valve is provided with a sufficient high current even during the holding phase.

In a variation of the invention the current is controlled during the holding phase onto an effective, usually constant value.

In its embodiments the procedure is implemented during activation. Furthermore it can be implemented among others when an efficiency of a current source, which is arranged as a battery and which provides current during the holding phase at an default operation, is too low. Thus the awarding accuracy of the injection valve can be guaranteed.

The invention concerns furthermore a device for controlling the injection valve, which is customized to cause that the injection valve is provided with current by a condenser during the holding phase, during which the injection valve is closed.

This means for an embodiment that the device is customized to control the condenser as well as a battery as an additional current source for the injection valve, so that the current sources supply the injection valve with current depending on the demand, whereby the battery and the condenser can be engaged with the injection valve. In doing so a regulation can take place by engaging a solenoid valve on to a voltage of the battery. An engaging of the condenser can take place during the first phase and also additionally during the holding phase.

The device is customized in one embodiment in order to cause the provision of the current during the holding phase by the condenser, when an efficiency of the battery, which provides the current during the holding phase at a default operation, is too low. With the device, which can be arranged as a controller, the injection valve as well as a current source that is arranged as a condenser are to be controlled and thereby to be regulated and/or controlled. For supplying the injection valve with current the device provides typically a current profile that is applicable for each operating point of the injection valve. Therefore the device can directly or indirectly control the injection valve, especially a high pressure injection valve, as well as other engine components, which collaborate with the injection valve and/or are dependent on a function of the injection valve. In an embodiment the device can be arranged to control the current sources, typically the condenser and the battery and/or a circuit arrangement, through which usually current flows from the battery and the condenser to the injection valve, by an applicable wiring.

At a default operation the device is arranged, for example by the provision of a current profile, to adjust the circuit arrangement so that the current flows during the first phase, the so-called booster phase from the condenser to the injection valve. During the booster phase the device controls the circuit arrangement in such a way, that the current is provided during a default operation by the battery. At an activation of the engine and/or in the case that a voltage and thus the current from the battery is too low, the device controls the two current sources and/or the circuit arrangement in such a way, that during the holding phase alternatively or at least additionally to the current, which is provided at an default operation usually only by the battery, the current is now also provided by the condenser.

It is provided that all steps of the procedure for controlling the injection valve, usually a high pressure injection valve for the engine of a motor vehicle, and thus altogether for controlling or regulating the injection valve by the described device can be implemented. Individual functions of the device can be implemented as steps of the procedure according to the invention.

The computer program with program code devices according to the invention is customized to implement all steps of a procedure according to the invention, if the computer program runs on a computer or a corresponding central processing unit, especially on a device according to the invention.

The further provided computer program product with program code devices according to the invention, which are stored on a computer readable medium, is customized for implementing all steps of a described procedure, if the computer program runs on a computer or a corresponding central processing unit, especially on a device according to the invention.

With the invention a keeping open of the high pressure injection valve (HDEV) is achieved among others by regulating the current with a booster voltage that is provided by the booster condenser, also during the holding phase.

An alternative of the invention allows it to provide the necessary fuel amounts for a hot start or a repeated cold start with the high pressure injection valve also at a low battery voltage, high fuel pressure and high valve flow rate. One operating range of the high pressure injection valve can be thereby extended as to a solenoid temperature, a battery voltage, a system pressure and a fuel flow rate.

At a normal operation the highest system pressure is determined by opening a pressure limitation valve at a gasoline direct injection. An opening pressure of the pressure limitation valve is for example caused by a hot start, in other words by an activation after a parking phase, at which a pressure boost occurs in the fuel high pressure system due to the heating of the fuel. The heating of the fuel in the fuel system occurs by the heat transfer of a previously in full load driven and therefore intensively heated up engine. Furthermore the battery voltage usually collapses at the activation due to the triggering of the starter. The disadvantageous combination between the necessary high system pressure, against which the high pressure injection valve has to be kept open, and a low battery voltage, with which the current is generated in the holding phase, can lead to an early closing of the injection valve and therefore to an emaciation of the activation injections due to the insufficient effective holding current, which can lead to dropouts with a corresponding impairment of exhaust gas values and of the activation performance up to a complete activation failure.

Another disadvantageous combination is for example the repeated cold start. In this case the engine is activated at a low ambient temperature and driven for a few minutes with a high load. When turning it off the pressure quickly increases in the rail up to a pressure limitation valve pressure due to the high temperature difference. At a repeated activation the battery voltage collapses intensively and the valves have to be kept open against the high pressure.

With the invention the holding phase is replaced among others by a battery voltage independent, longer booster phase. Thus the mentioned emaciation of the injections at a hot start and repeated cold start can be avoided.

Further advantages and embodiments of the invention arise from the description and the enclosed drawing.

It shall be understood that the previously mentioned and the following still to be explained characteristics are applicable not only in the specified combination, but also in other combinations, without leaving the frame of the present invention.

The invention is schematically shown in the drawing by means of embodiments and is explicitly explained in the following with reference to the drawing.

### BRIEF DESCRIPTION OF THE DRAWINGS

FIG. 1 shows in a schematic illustration examples of diagrams for parameters of an injection valve in a standard operation status.

FIG. 2 shows in a schematic illustration examples of diagrams for parameters of an injection valve at a low battery voltage.

FIG. 3 shows in a schematic illustration examples of diagrams for parameters of an injection valve at an additional current withdrawal by a condenser during a holding phase.

FIG. 4 shows an example for the arrangement, which provides an embodiment of a device according to this invention.

### DETAILED DESCRIPTION

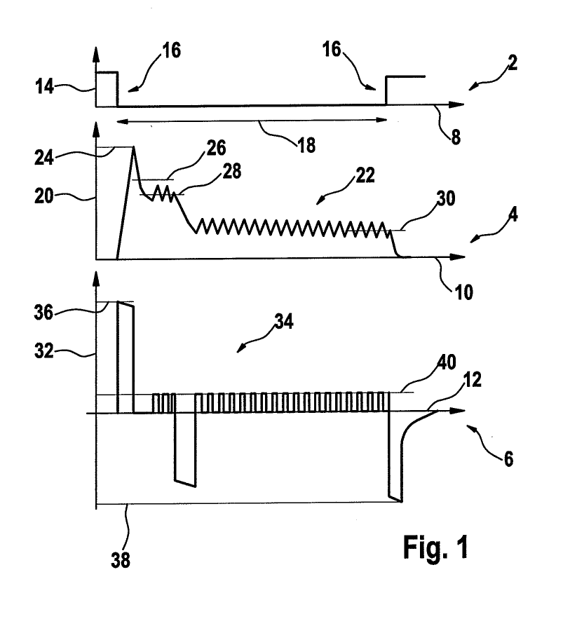

FIG. 1 shows a first, a second and a third diagram 2, 4, 6, in which one parameter for clarification of an activation profile at a standard operating status for an injection valve that is arranged as a high pressure injection valve is entered each over time axes 8, 10, 12. The time axes 8, 10, 12 cover a few milliseconds [ms] in the sectors that are shown in the diagrams 2, 4, 6. Thereby these time axes 8, 10, 12 are so arranged on top of each other, that for the values of parameters that are shown over the diagrams 2, 4, 6 a simultaneous temporal course of these parameters is shown.

Hereby a value of an activation signal 16, which is provided by a controller, is entered as parameter in the first diagram 2 in direction of a vertical signal axis 14. Thereby the value of the activation signal 16 amounts to zero during a time interval 18. Before and after the time interval 18 a constant value is provided for the activation signal 16.

In the second diagram 4 from FIG. 1 a current strength is entered along a vertical current axis 20 in ampere. Hence a course of a current profile 22, with which the injection valve has to be supplied with current, so that a current flows through the injection valve, is shown in the second diagram 4.

This current profile 22 covers in detail a steep boost, which is completed until reaching a so-called maximum booster current 24. This first phase of the current profile 22 is also called booster phase.

After reaching the booster current 24 it is provided that the current profile 22 is reduced. Such a reduction accompanies an operating phase of the current profile, whereby the current is regulated to an effective operating current that is marked by a second line 28. This phase of the current profile is called operating phase. The effective value for the current strength during the booster- and operating phase is shown by line 26.

After the operating phase of the current profile 22 a further reduction of the current profile 22 takes place. A holding phase of the current profile 22 that is connected with that is regulated to an effective hold current that is shown by a third line 30. Afterwards a value of the current profile 22 falls to a value of 0 ampere.

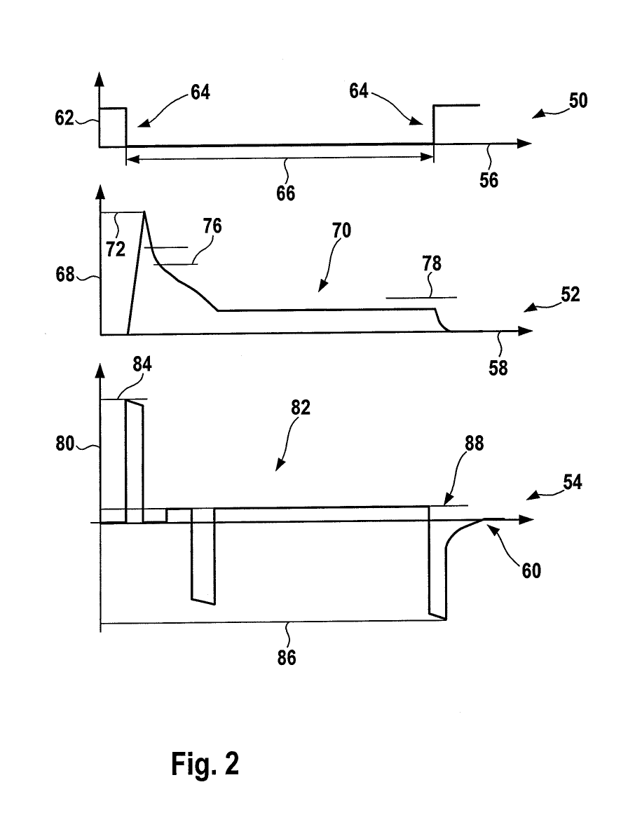

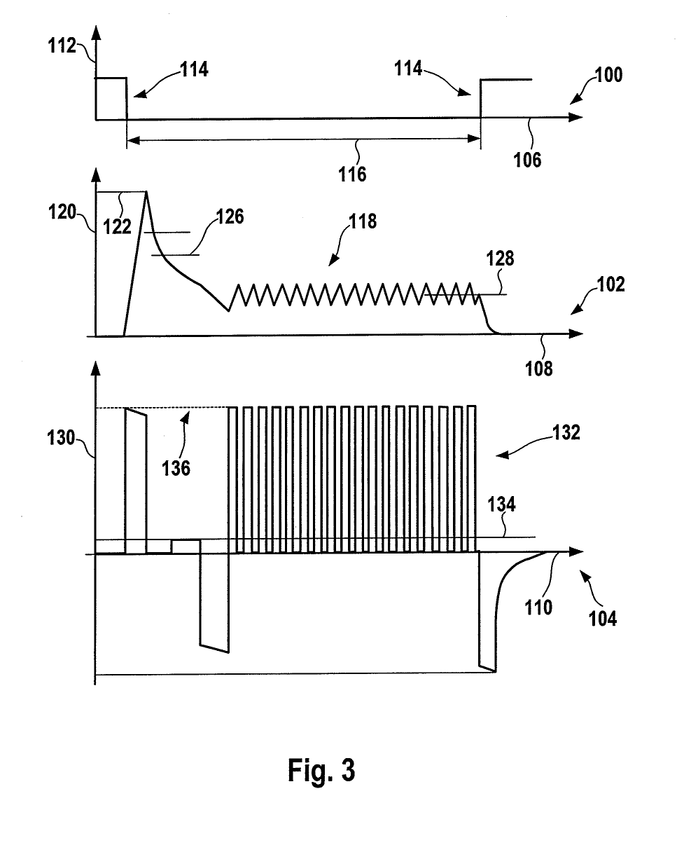

During the activation of the injection valve it is provided that the opening of the injection valve is initiated during the booster phase until reaching the booster current 24. During the operating phase, at which the current profile 22 is regulated to an effective operating current (second line 28), the injection valve is opened completely. During the following holding phase of the current profile 22 the injection valve is kept open. It shall be pointed out that the diagrams of the following FIGS. 2 and 3 are also each divided into booster-, operating- and holding phases.

Within the second diagram 4 it is clarified by a zigzagged course of the current profile 22 that the current profile 22 is regulated during the operating phase as well as during the holding phase on to the effective operating value and to the effective holding value.

The third diagram 6 shows a value 34 of a voltage that is adjacent to connections and therefore pins of the injection valve along a voltage axis 32. This value 34 for the measured voltage shows in the third diagram at the beginning and therefore until the end of the booster phase a maximum booster voltage 36 and at the end, in this case when finishing the holding phase, a maximum negative booster voltage 38.

It follows from a comparing view of the second and third diagram 4, 6 under consideration of the time axes 10, 12, that a peak with the maximum positive booster voltage 36 during the steep boost of the current profile 22 is reached. During the operating phase a rectangular shaped course of the value 34 for the voltage is present, whereby the voltage reaches maximally a value of a battery voltage that is shown by line 40. When crossing from operating phase to holding phase the voltage 34 reaches a minimal value. During the holding phase the value of the measured voltage 34 moves between 0 volt and a maximal battery voltage that is shown by line 40.

Corresponding to FIG. 1 FIG. 2 shows also three diagrams 50, 52, 54 for parameters of activation profiles for the injection valve at lower battery voltage with horizontal time axes 56, 58, 60.

Thereby a first diagram 50 shows along a signal axis 62 a value for an activation signal 64 of a controller, which is zero during a time interval 66.

In the second diagram 52 a current profile 70 for the case of a low battery voltage is shown along the vertical current axis 68. In this case a maximum booster current 72 is reached during a steep boost during the first phase, the boosting phase. During the following operating phase an effective value of the current profile 70 is shown by line 76. During the holding phase, during which the injection valve is closed, the reached value of the current profile 70 lies below a value of a holding current that has usually to be reached and that is shown by line 78.

In the third diagram a value 82 for a voltage that is adjacent to and measured at the injection valve is shown along a voltage axis 80. Thereby the voltage reaches at the beginning a maximum booster voltage (line 84) and at the end a maximum negative booster voltage (line 86). In between the voltage maximally reaches a reduced here constant battery voltage (line 88).

FIG. 3 shows diagrams 100, 102, 104 for activation profiles for parameters of an injection valve at a low battery voltage with additional current withdrawal from a condenser that is arranged as a booster condenser during the holding phase. Also in these three diagrams 100, 102, 104, as well as in diagrams 2, 4, 6 from FIG. 1 and in 50, 52, 54 from FIG. 2 the horizontal time axes 106, 108, 110 are arranged on top of each other.

Thereby in a first diagram 100 along a vertical signal axis 112 a value for an activation signal 114 is shown, which is like in the previously described examples during the time interval 116 zero.

A current profile 118, which is shown in the second diagram 102 along a current axis 120, shows, like the previous examples, first a steep boost until reaching a so-called booster current (line 122). It is provided that this steep boost is provided by a condenser that is arranged as a booster condenser.

After reaching the maximum booster current the injection valve is completely opened, whereby a current strength is reduced and provides an effective operating current, which is marked in this second diagram by line 126.

Since the battery voltage is reduced in the present case, an additional current is provided in the following holding phase, also by the booster condenser, so that during the holding phase, which is accompanied by a closing of the injection valve, as shown by line 126, is reached. Thereby current flows through the injection valve during the holding phase that is higher than in the case of the second diagram 52 from FIG. 2.

The measure to use also the booster condenser for supplying the injection valve with current during the holding phase affects also the value of the voltage value 142 that is shown in the third diagram 104 along a voltage axis 130. The value 134 of the voltage during the holding phase exceeds now easily the effective value of a battery voltage that is indicated by line 134. In this case the rectangularly shaped voltage alternatively reaches a minimum value 132 of 0 volt and a maximum value 136, which corresponds with the booster voltage.

The current in the holding phase of the activation of the high pressure injection valve is usually taken from the battery, whereby the required effective holding current is maintained by a current regulation (FIG. 1, 2^{nd} diagram 4). If the battery voltage is low as for example at a cold start the effective holding current cannot be maintained, and the valve can close early (FIG. 2). With a flexible configuration of the activation course of the valve the current in the holding phase can be provided by the present booster condenser. In this case the current in the holding phase is battery voltage independent, and the required, effective holding current can be reached and maintained, as FIG. 3 shows. Usually the energy is taken from the booster condenser only during the booster phase. A reason for it is the time that is required for recharging the booster condenser. Due to the low engine speed during the activation the ability of recharging the booster condenser is provided, so that now current of the booster condenser can be used also during the holding phase.

After the activation is finished or when reaching a sufficient battery voltage and/or when falling below a specific pressure threshold, the holding phase transfers from current regulation from the booster condenser in to current regulation from the battery voltage.

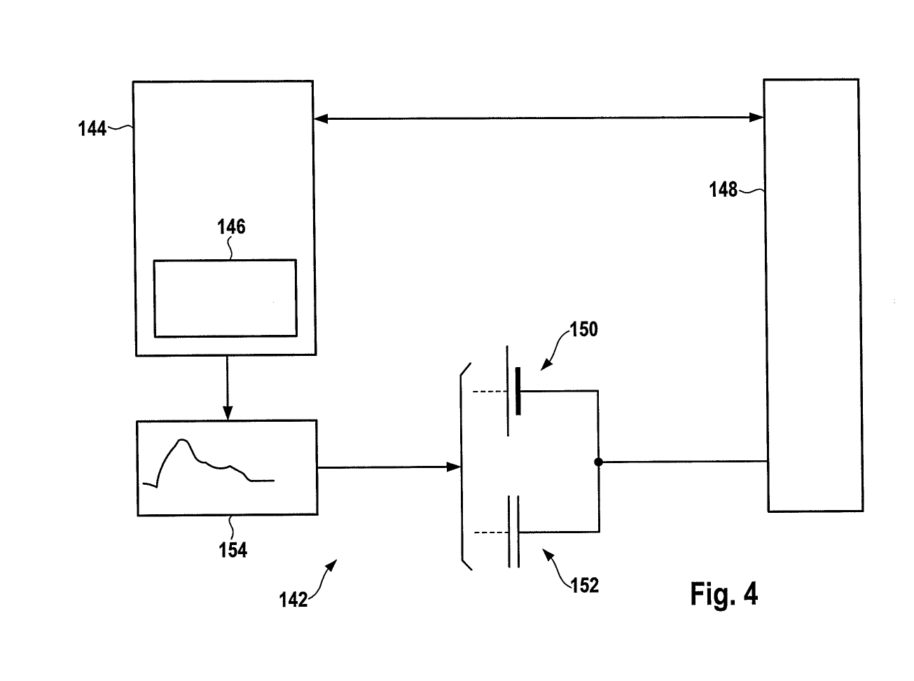

FIG. 4 shows a configuration 142, which provides an embodiment of a device 144 according to the invention with a final stage module 146 as well as a battery 150 and a condenser 152, which are arranged as current sources for the injection valve 148.

The device 144 according to the invention, which is here arranged as a controller, is provided for controlling the injection valve 148, whereby the device 144 of this embodiment controls the status of the injection valve. To realize an embodiment according to the invention it is provided that the device 144 has to provide a current profile 154 for an electric current, with which the injection valve 148 has to be supplied, so that this current profile 154 covers in a first step a steep, at least once discontinued boost until the boost current that has been described by means of the previous FIGS. 1-3 is reached.

During the holding phase that has been described in the previous FIGS. 1-3, at which the injection valve 148 is held open after an undertaken opening, it is usually provided, that meanwhile the battery 150 serves as current source for the injection valve 148. A required range of current sources for each phase for supplying the injection valve with current is undertaken by the device 144, which conveniently wires up at least one of the current sources with the current profile 154.

The present embodiment of the invention provides, that in the case of a battery voltage of the battery 150 being too low, even during the holding phase a current is delivered to the injection valve 148 by the condenser, which is otherwise only used for supplying current during the first phase to reach the steep boost. Therefore the device 144 is customized to control the battery voltage as well as further parameters, which influence the supply of current to the injection valve 148. If the case arises that the battery voltage is too low for example during a hot start or a cold start, then the device 144 according to the invention is qualified to control and therefore wire up the current sources in such a way that the injection valve 148 is now supplied by the condenser with current that has a sufficient high current strength.

1. Procedure for controlling an injection valve (148), at which the injection valve is supplied with current, which is provided by a condenser (152), during a holding phase, at which the injection valve (148) is kept open.

2. Procedure according to claim 1, at which the current is provided by the condenser (152) during a first phase, at which the injection valve (148) is opened and which precedes the holding phase.

3. Procedure according to claim 2, at which the current is regulated during the holding phase on to an effective value.

4. Procedure according to one of the previous claims, which is implemented during an activation process.

5. Procedure according to one of the previous claims, which is implemented when a voltage of a battery (150), which provides the current during a holding phase, is too low.

6. Procedure according to one of the previous claims, at which a measuring accuracy of the injection valve (148) is controlled.

7. Device for controlling an injection valve (148), which is customized to cause that a condenser (152) provides the injection valve (148) with a current during a holding phase, at which the injection valve (148) is kept open.

8. Device according to claim 7, which is customized to control the condenser (152) as well as a battery (150) as a further current source for the injection valve (148).

9. Device according to claim 8, which is customized to cause a provision of current during the holding phase by the condenser (152), if a voltage of the battery (150), which provides current during the holding phase at a standard operating status, is too low.

10. Computer program with program code devices, in order to implement all steps of a procedure according to one of the claims 1-6, if the computer program is executed on a computer or a corresponding central processing unit, especially in a device (144) according to claim 10 or 11.

11. Computer program with program code devices, which are saved on a computer readable medium, in order to implement all steps of a procedure according to one of the claims 1-6, if the computer program is executed on a computer or a corresponding central processing unit, especially in a device (144) according to claim 10 or 11.
